(19) United States
(12) Patent Application Publication
(10) Pub. No.: US 2025/0121960 A1
(43) Pub. Date: Apr. 17, 2025

(54) HEAT CONTROL STRUCTURE AND SATELLITE HAVING THE SAME

(71) Applicant: PANASONIC HOLDINGS CORPORATION, Osaka (JP)

(72) Inventors: Mengu CHO, Fukuoka (JP); Hirokazu MASUI, Fukuoka (JP); Kazuma OIKAWA, Osaka (JP); Ryou KUWABARA, Osaka (JP); Takashi TSURUTA, Osaka (JP); Masato MORI, Hyogo (JP)

(21) Appl. No.: 18/999,222

(22) Filed: Dec. 23, 2024

Related U.S. Application Data
(63) Continuation of application No. PCT/JP2023/014369, filed on Apr. 7, 2023.

(30) Foreign Application Priority Data
Jun. 30, 2022 (JP) 2022-105873

(51) Int. Cl. B64G 1/50; B64G 1/58; F16L 59/02; H01M 10/615; H01M 10/625; H01M 10/6571; H01M 10/658; H01M 50/202; H01M 50/249

(52) U.S. Cl. CPC B64G 1/50; B64G 1/58; F16L 59/028; H01M 10/615; H01M 10/625; H01M 10/6571; H01M 10/658; H01M 50/202; H01M 50/249; H01M 2220/20

(57) ABSTRACT

A heat control structure includes a heat insulator disposed between a housing for accommodating a heat control target mounted on a satellite and the heat control target. The heat insulator is disposed so as to be in contact with the housing and the heat control target, the heat insulator contains at least silica aerogel, and the heat insulator has a thermal resistance of 0.02 (m²·K)/W or more.

### CROSS-REFERENCE TO RELATED APPLICATIONS

The present application is a continuation of PCT/JP2023/014369 filed Apr. 7, 2023, which claims priority to Japanese Patent Application No. 2022-105873, filed Jun. 30, 2022, the entire contents of each of which are incorporated herein by reference.

### TECHNICAL FIELD

The present disclosure relates to a heat control structure including a heat insulator disposed between a housing that houses a heat control target mounted on a satellite and the heat control target, and to a satellite having the same.

### BACKGROUND ART

The thermal environment surrounding spacecraft such as artificial satellites and rockets flying in outer space is extremely harsh. In this harsh temperature environment, the purpose of heat control is to control the temperature of the onboard equipment mounted on the spacecraft to a range of approximately-30 to 60° C., although this may vary slightly depending on the requirements of the equipment, or to a range of 0 to 30° C. if a storage battery is installed. If the thermal problems of a spacecraft are not handled appropriately, they can bring about failure of the onboard equipment or malfunction of the entire spacecraft system.

The temperature of a spacecraft in orbit is determined by the balance among (1) external heat inputs such as sunlight, the Earth's albedo, and Earth's infrared radiation, (2) internal heat generation from onboard equipment, and (3) the amount of heat dissipated into space from the spacecraft itself. In this case, the crucial difference from on Earth is that, because space is an ultra-high vacuum, thermal convection, which is the main method of heat control on Earth, cannot be used. Hence, the main heat control of a spacecraft relies on thermal radiation and thermal conduction. If a spacecraft in orbit is continuously exposed to direct sunlight without any heat control, the spacecraft will inevitably become hotter. Conversely, if the spacecraft enters the Earth's shadow and is continuously exposed to a cold and dark state, the temperature of the spacecraft will drop drastically. For this reason, a thermal design is made for a spacecraft that takes temperature balance into consideration, and the necessary heat control equipment is installed based on the results of the design.

In particular, small satellites as spacecraft have a smaller heat capacity than medium and large satellites, so that the temperature of the main structure and onboard equipment fluctuates greatly in orbit. There are two main types, passive type and active type, as heat control methods that have been adopted for satellites so far.

Regard the satellite as a box, i.e., a housing, and assume that electronic devices with an operating temperature range close to room temperature are mounted inside the box. In this state, because of the harsh space environment, it is difficult for the satellite (electronic devices) to maintain a temperature close to room temperature due to the extreme temperature history. For this reason, the entire box is covered with a heat insulation blanket (multilayer heat insulator) to block the exchange of heat with outer space. However, the electronic devices consume power during operation, most of which becomes heat and raises the temperature inside the satellite, and in order to maintain the temperature close to room temperature, the excess heat must be discarded outside the satellite (to outer space). To this end, it is necessary to cut out a part of the heat insulation blanket to provide a window (radiator) for heat dissipation. Since heat is dissipated into space only by radiation, it is possible to maintain the inside of the satellite at a temperature close to room temperature by appropriately designing the emissivity & of this window. However, since sunlight may enter the radiator part, it is necessary to consider the solar absorptance (as). The radiator part is often coated with a material having a high emissivity & and a low solar absorptivity as. Deployable radiators using graphite for the heat dissipation part are also known (see, e.g., Patent Document 1: JP 2008265522A). The method of keeping the temperature of onboard equipment within a desired temperature range by selecting the shape of each part of the satellite and the thermal properties of the materials in this manner is called passive heat control.

Many small satellites do not have large solar battery panels that expand widely outside the satellite body, and their solar battery panels are mounted on the surface of the satellite body, so that they do not have enough power to actively control the temperature of all electronic devices with a narrow allowable temperature range. Due to these constraints, passive heat control is the most practical heat control method for many small satellites. Passive heat control is superior in terms of reliability because it has no mechanical moving parts and requires no power.

When the amount of heat generated by electronic devices mounted on a satellite and the fluctuations in the amount of heat generated become large, even if the temperature can appropriately be controlled at the time of maximum heat generation, the devices will become too cold when the amount of heat generated diminishes. In such a case, passive heat control is not sufficient, and measures such as incorporating a heater for temperature compensation or attaching a thermal louver to the outside of the radiator to change the effective emissivity are required. Heat transfer inside the satellite is carried out by radiation and conduction. However, if a part of the satellite still becomes hot by these means alone, the temperature distribution inside the satellite must be equalized by transporting heat from the high temperature part to the low temperature part using heat pipes, etc., to control the temperature environment to be comfortable for the mounted devices. This more proactive heat control method using heaters, thermal louvers, heat pipes, etc. is called active heat control.

Small satellites have small thermal capacities and are, so to speak, easy to cool down and easy to heat up. For this reason, many small satellites currently employs a heat control system that combines passive and active types.

As satellite missions become more diverse, sophisticated, and complex, the sophistication and advancement of heat control methods to make effective use of limited power resources is the most important issue in light of the future development of the space industry, and in order to solve this issue, further refinement of heat control methods is necessary.

### SUMMARY OF INVENTION

### Technical Problem

When a satellite enters the shadow of the Earth and is continuously exposed to a cold and dark environment, the temperature of the satellite drops drastically. Batteries mounted on satellites, such as lithium-ion batteries (LiBs), will not work well in a negative temperature environment, which may trigger malfunctions of the onboard equipment and the satellite system as a whole. It was therefore necessary to heat the batteries with a temperature compensation polyimide heater (PIH) before the temperature of the batteries drops to or below 0° C. to adjust the temperature of the batteries so that the batteries can operate. At this time, there is a problem that valuable power is used for heater heating, which limits the power used by the mission equipment. Even if the entire satellite is covered with a conventional insulation blanket (multilayer heat insulator), there still remains a problem that a satellite with a small thermal capacity cannot avoid its and batteries' temperature drop to or below 0° C. in a cold or dark environment and hence that valuable electric power is consumed for heater heating. These issues are not limited to batteries, but are common to all heat control targets such as electronic devices mounted on satellites.

Thus, an object of the present disclosure to solve the above conventional problems and to provide a heat control structure that can better suppress abrupt temperature rise and drop in heat control targets mounted on a satellite, and a satellite including such a heat control structure.

### Means for Solving Problem

A heat control structure according to one aspect of the present disclosure is a heat control structure includes a heat insulator disposed between a housing for accommodating a heat control target mounted on a satellite and the heat control target. In this heat control structure, the heat insulator is disposed so as to be in contact with the housing and the heat control target, the heat insulator contains at least silica aerogel, and the heat insulator has a thermal resistance of 0.02 (m²·K)/W or more.

A satellite according to one aspect of the present disclosure includes a heat control target, a housing that houses the heat control target, and a heat control structure that has a heat insulator disposed between the housing and the heat control target. In the heat control structure of the satellite, the heat insulator is disposed so as to be in contact with the housing and the heat control target, the heat insulator contains at least silica aerogel, and the heat insulator has a thermal resistance of 0.02 (m²·K)/W or more.

### Effect of Invention

According to the present disclosure, there can be provided a heat control structure capable of better suppressing abrupt rise and drop in temperature of a heat control target mounted on a satellite, and a satellite including such a heat control structure.

### BRIEF DESCRIPTION OF DRAWINGS

FIG. 1 is a schematic diagram of a heat control structure according to an embodiment of the present disclosure.

FIG. 2 is a diagram showing the relationship between the thickness and heat conductivity of a heat insulator.

FIG. 3 is a graph showing the vacuum degree dependence of the heat conductivity of the heat insulator.

FIG. 4 is a schematic diagram of a heat control structure according to a comparative example against the embodiment.

### DESCRIPTION OF EMBODIMENT

### Aspects of the Disclosure

A heat control structure according to a first aspect of the present disclosure is a heat control structure includes a heat insulator disposed between a housing for accommodating a heat control target mounted on a satellite and the heat control target. The heat insulator is disposed so as to be in contact with the housing and the heat control target, the heat insulator contains at least silica aerogel, and the heat insulator has a thermal resistance of 0.02 (m²·K)/W or more.

The heat control structure according to a second aspect of the present disclosure is such that in the first aspect, the heat insulator has a first surface in contact with the heat control target and a second surface opposite the first surface in contact with the housing, wherein the first surface has an area 1.2 times or more a contact area of the first surface in contact with the heat control target.

The heat control structure according to a third aspect of the present disclosure is such that in the first or second aspect, the heat insulator is silica aerogel.

The heat control structure according to a fourth aspect of the present disclosure is such that in the first or second aspect, the heat insulator includes silica aerogel and non-woven fibers.

The heat control structure according to a fifth aspect of the present disclosure is such that in the first or second aspect, the heat insulator includes silica aerogel, non-woven fibers, and a carbon material.

A satellite according to a sixth aspect of the present disclosure includes a heat control target, a housing, and the heat control structure of any one of the first to fifth aspects.

The satellite according to a seventh aspect of the present disclosure includes, in the sixth aspect, a battery, a heater disposed around an exterior of the battery, and a battery box that houses the battery and the heater, wherein the battery and the heater are the heat control targets, wherein the battery box is the housing, and wherein the heat insulator is disposed between the battery and the housing and between the heater and the housing.

### Embodiment

An embodiment of the present disclosure will hereinafter be described with reference to the drawings.

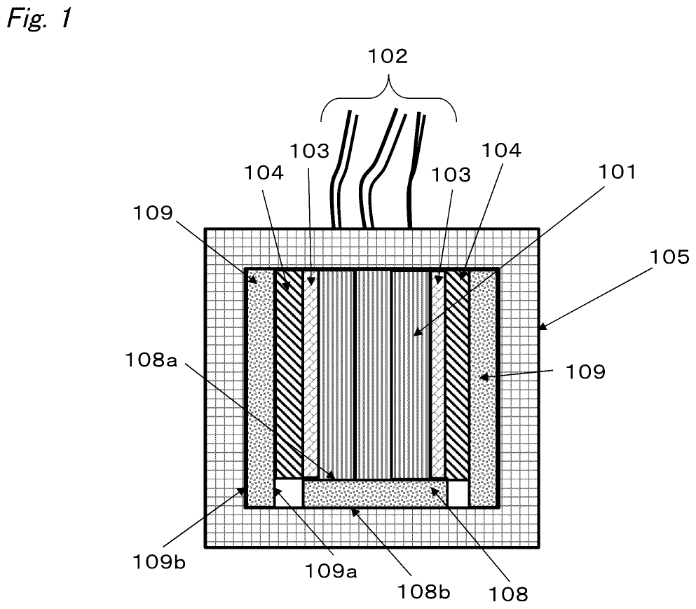

FIG. 1 is a diagram showing a schematic configuration of a heat control structure according to an embodiment of the present disclosure. As an example of the heat control structure of the present embodiment, a heat control structure will be described that performs heat control for a battery 101 housed in a battery box 105 mounted on a satellite, for example, a small artificial satellite. The small artificial satellite generally refers to one having a longitudinal length of 50 cm or less and a weight of 50 kg or less, but there is no clear definition. Thus, in the present disclosure, a small artificial satellite is a satellite of approximately 200 cm or less and 200 kg or less.

The battery box 105 is a box-shaped housing that adopts various sizes and shapes depending on the space inside the artificial satellite and the shape of the battery 101 housed therein. Heat input to the outer surface of the battery box 105 from sunlight and other sources is thermally conducted from the outside to the inside of the battery box 105. Heat input to the inner surface of the battery box 105 from the battery 101 and other sources is thermally conducted from the inside to the outside of the battery box 105. That is, the battery box 105 is also a thermally conductive member that conducts heat to the inside and outside of the battery box 105. In the present embodiment, the battery box 105 is formed of a metal material that has relatively high heat resistance and strength. The housing houses inside the battery 101 that is an object to be thermally controlled, but may have an opening a part thereof.

As shown in FIG. 1, a cylindrical lithium ion battery (hereinafter referred to as battery) 101 is mounted on a battery box 105 as a power source for various missions of the artificial satellite. The battery 101 is connected to a solar panel (not shown) via a lead wire 102. The battery 101 can be charged with power generated by the solar panel via the lead wire 102 or can supply power to electronic devices inside the satellite.

The battery 101 is wrapped around its outer circumference with a heater 104 via a buffer material 103 such as silicone rubber. A thin planar heat generation element is preferably used as the heater 104, and for example, a polyimide heater (a planar heat generation element integrating a foil conductor and polyimide resin) having high heat resistance may be used. When the artificial satellite enters the shadow of the Earth and is exposed to a cold and dark environment, the heater 104 heats the battery 101 so that the battery 101 does not become too cold and malfunction. For example, when the surface temperature of the battery 105 detected by a temperature sensor not shown falls to 0° C. or below, the heater 104 is activated to heat the battery 101. The heater 104 is arranged via the buffer material 103 so as to cover the circumferential surface of the cylindrical battery 101.

A heat insulator 108 is disposed between the bottom surface of the battery 101 (the lower surface of the battery 101 in FIG. 1) and the battery box 105. The heat insulator 108 has a first surface 108a that is in contact with the bottom surface of the battery 101 and a second surface 108b that is the surface opposite to the first surface 108a and that is in contact with the inner surface of the battery box 105. By disposing the heat insulator 108 between the bottom surface of the battery 101 and the battery box 105 in a sandwiched manner, heat transfer between the both is blocked.

A heat insulator 109 is also disposed between the heater 104 and the battery box 105 so as to be sandwiched therebetween. The heat insulator 109 has a first surface 109a that is in contact with the heater 104 and a second surface 109b that is the surface opposite to the first surface 109a and that is in contact with the inner surface of the battery box 105. The heat insulator 109 blocks heat transfer between the circumferential surface, i.e., side surface of the battery 101, and the battery box 105. Furthermore, the heat insulator 109 blocks the outflow of heat from the heater 104 to the battery box 105 side when the heater 104 is in operation, to act transfer more heat to the battery 101. The heat insulator 109 blocks from one side heat that spreads isotropically to the front and back of the heater 104, thereby providing a heat rectifying function and a heat retaining effect. From this viewpoint, in the present embodiment, the battery 101 and the heater 104 are an example of a heat control target for which heat control is performed by a heat control structure using the heat insulators 108 and 109.

The area of the first surface 108a of the heat insulator 108 arranged on the bottom surface of the battery 101 is preferably equal to the area of the first surface 108a that is in contact with the bottom surface of the battery 101, and more preferably 1.2 times or more. The area of the first surface 109a of the heat insulator 109 arranged on the side surface of the battery 101 is preferably equal to the area of the first surface 109a that is in contact with the heater 104, and more preferably 1.2 times or more. By setting the size to 1.2 times or more, the effect of preventing heat from going around and entering is enhanced. It is preferable that the heat insulators 108 and 109 be in contact with the battery box 105 over almost the entire second surfaces 108b and 109b. It is preferable to use as the heat insulators 108 and 109 a heat insulator having a high thermal resistance of 0.02 (m²·K)/W or more.

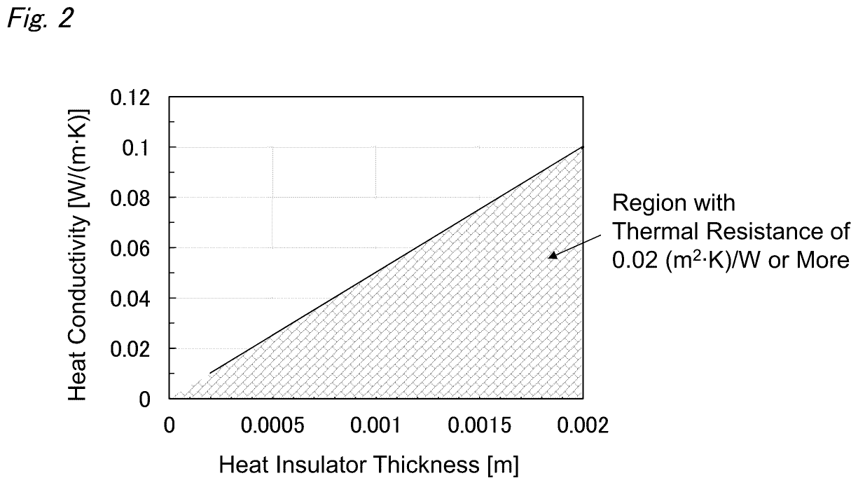

FIG. 2 shows a relationship between the thickness (abscissa axis: m) and the heat conductivity (ordinate axis: W/(m·K)) of the heat insulator. Since there is only a limited narrow space left inside the battery box 105 due to the presence of the battery 101 and the heater 104, the space to arrange the heat insulators 108 and 109 is limited. The thickness of the heat insulator allowed to be arranged in such a space is preferably 2.0 mm or less, and more preferably 1.5 mm or less. When the thickness of the heat insulator is 2.0 mm, in order to achieve a thermal resistance of 0.02 (m²·K)/W or more, the heat conductivity of the heat insulator needs to be at least 0.1 W/(m·K) or less. There are cases where the space allowing the arrangement of the heat insulators 108 and 109 is even narrower. For example, assume the heat conductivity required for the heat insulators 108 and 109 in the case where only a 1.0 mm thick heat insulator is allowed to be sandwiched. For example, when the thickness of the heat insulators 108 and 109 is 1.0 mm, in order to achieve a thermal resistance of 0.02 (m²·K)/W or more, the heat conductivity of the heat insulator must be at least 0.05 W/(m·K) or less. Thus, the narrower the space allowing the arrangement of the heat insulators 108 and 109, the lower the heat conductivity that the heat insulator must have in order to achieve the desired heat insulation effect.

Examples of heat insulators with a heat conductivity of 0.1 W/(m·K) or less, more preferably 0.05 W/(m·K) or less, include foamed polymers such as urethane foam and polystyrene foam, and nonwoven fibers made of polyester, nylon, etc. However, none of these heat insulators meet the heat resistance and flame retardancy specifications required for the heat insulators 108 and 109 mounted on artificial satellites. Since a silica aerogel composite heat insulator satisfies these specifications, it is preferred to use a thin silica aerogel composite heat insulator as the heat insulators 108 and 109.

The thin silica aerogel composite heat insulator is a composite material of silica aerogel containing silica nanoparticles connected three-dimensionally in a network structure with communicating pores, and nonwoven fibers. The thin silica aerogel composite heat insulator is composed mainly of silica and therefore excellent in heat resistance and flame retardancy, and has specifications and reliability that are perfect for being mounted on satellites. The heat conductivity of the thin silica aerogel composite heat insulator varies depending on the raw materials, gelling agent, process conditions, and material processes such as the type and basis weight of nonwoven fibers. The heat conductivity of the thin silica aerogel composite heat insulator is as very low as 0.02 to 0.05 W/(m·K) or less under normal pressure conditions, and even a 1.0 mm thick heat insulator has a thermal resistance of 0.05 to 0.02 (m²·K)/W, providing sufficient heat insulation effect.

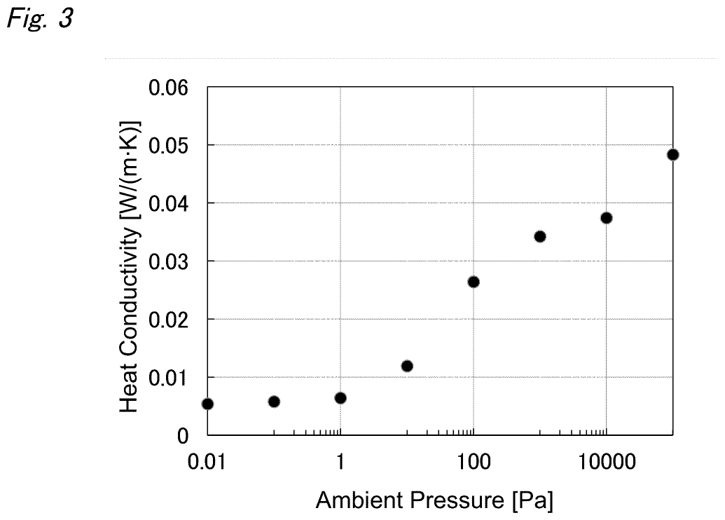

FIG. 3 shows the vacuum degree dependence of the heat conductivity of a silica aerogel composite heat insulator using non-woven glass fibers as the base material. The heat conductivity of the silica aerogel composite heat insulator was measured by the guarded hot plate (GHP) method. In FIG. 3, the ordinate axis represents heat conductivity (W/(m·K)) and the abscissa axis represents ambient pressure (Pa). The silica aerogel composite heat insulator showed a heat conductivity of 0.0483 W/(m·K) when the ambient pressure was an atmospheric pressure (10⁵ Pa), and the heat conductivity decreased as the ambient pressure was reduced. When the ambient pressure was a vacuum environment (10⁻² Pa), the silica aerogel composite heat insulator showed a very low heat conductivity of 0.0054 W/(m·K). It can be seen that the silica aerogel composite heat insulator behaves as a pseudo vacuum heat insulator in outer space that is a vacuum environment. Thus, by using silica aerogel composite heat insulator as the heat insulators 108 and 109 at appropriate locations within the battery box 105, more advanced passive heat control can be achieved.

The silica aerogel composite heat insulator may contain at least one type of carbon material from the viewpoint of lowering the heat conductivity (enhancing the heat insulation) through radiation absorption and further improving the heat resistance and flame retardancy. The type of carbon material is not particularly limited as long as it can be composited with silica aerogel, and any known carbon material with excellent radiation absorption properties may be used such as graphite, graphene, carbon nanotubes, carbon nanohorns, fullerene, acetylene black, carbon black, ketjen black, or activated carbon. The form of the carbon material and its dispersion state in the silica aerogel are preferably in the form of filler or fine powder, and the particle size is 20 μm or less, preferably 1 μm or less, from the viewpoint of more densely compositing with the silica aerogel. It is preferable that the carbon material be uniformly dispersed in the silica aerogel, but the carbon material may be unevenly distributed on either the front side or the back side of the thin silica aerogel composite heat insulator as long as it is distributed approximately uniformly in the surface direction. The concentration of the carbon material in the silica aerogel composite heat insulator is preferably 0.05 to 10% by weight, and more preferably 0.1 to 5% by weight, from the viewpoint of lowering the heat conductivity through radiation absorption and improving the heat resistance and flame retardancy.

On the other hand, when launching a satellite, there are concerns about the physical strength required to withstand an impact of about 6G, the falling off of silica powder, and even dimensional changes in the heat insulator under vacuum. The silica aerogel composite heat insulator using glass fibers as the base material only deforms by about 5% even when subjected to a large load of 5 MPa in the thickness direction, and has very strong physical strength. By integrally covering the front and back of the heat insulator with an outer covering material such as laminate film or Kapton tape, the falling off of silica powder from the heat insulator can be prevented. The thickness of such an outer covering material should be as thin as possible, and preferably 0.050 mm or less.

The dimensional stability of the silica aerogel composite heat insulator under pressure fluctuations is less than 1% in each of the X, Y, and Z directions from dimensional comparisons in the atmospheric pressure (10⁵ Pa) and vacuum environment (10⁻² Pa), which is perfect for use in a space environment.

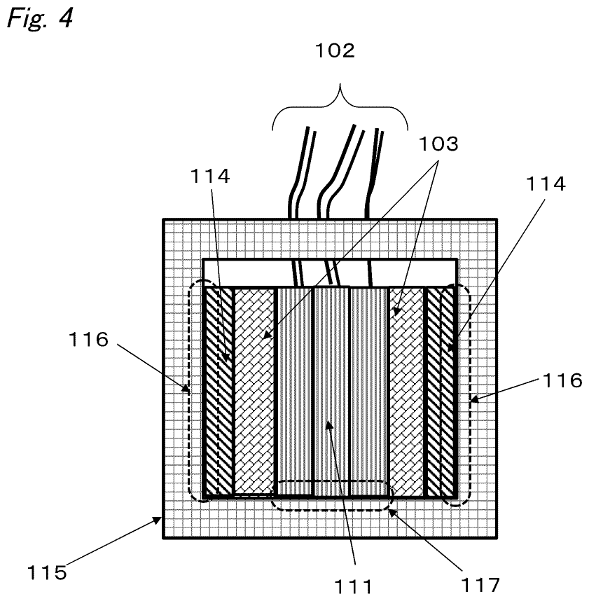

A heat control structure according to a comparative example against the present embodiment is shown in FIG. 4, which depicts a power supply configuration in the case where heat control as in the present embodiment is not effected. As shown in FIG. 4, in a battery box 115 according to the comparative example, no heat insulators 108 and 109 are arranged between a battery 111 and a battery box 115. In such a structure, heat transfer occurs easily at an interface 116 between a heater 114 and the battery box 115, or at an interface 117 between the battery 111 and the battery box 115. Hence, the power consumption due to the heater heating becomes larger than that of the heat control structure of the embodiment, resulting in limited power available for the satellite missions.

The heat control structure of the present embodiment is a heat control structure including the heat insulators 108 and 109 that are arranged between the battery box 105 that houses the battery 101 or the heater 104 mounted on a satellite, and the battery 101 or the heater 104. The heat insulators are arranged in contact with the battery box 105 and the battery 101. The heat insulators 108 and 109 contains at least silica aerogel and have a thermal resistance of 0.02 (m²·K)/W or more.

According to this configuration, the heat insulators 108 and 109 containing at least silica aerogel and having a thermal resistance of 0.02 (m²·K)/W or more are arranged between the battery 101 or the heater 104 and the battery box 105, so that the heat transfer therebetween can effectively be blocked. In other words, the contact point between the battery box 105 and the battery 101 can substantially be thermally insulated, and an abrupt temperature rise of the battery 101 can be mitigated even if the artificial satellite continues to be exposed to direct sunlight on orbit. Furthermore, even if the satellite enters the shadow of the earth and is exposed to a cold and dark environment, an abrupt temperature drop of the battery 101 can be prevented. As a result, the power consumption associated with the heater heating to warm the battery 101 can be reduced. In addition, the battery box 105 and the heater 104 can also substantially be thermally insulated from each other, and when the heater 104 is operating, the outflow of heat from the heater 104 to the battery box 105 side can be blocked, allowing more heat to be transferred to the battery 101. The heat insulators 108 and 109 containing silica aerogel have voids formed by communicating pores, so that no gas exists inside the heat insulators at an altitude of 400 km. Hence, in outer space, the heat insulators 108 and 109 behave as pseudo vacuum heat insulators inside the satellite, thereby providing more effective heat insulation effects.

The above description of the embodiment describes the heat control structure for effecting the heat control of the battery 101 mounted on the artificial satellite, but the heat control target is not limited to the battery alone. The heat control target may be an electronic device or electronic component mounted on the artificial satellite.

Although the example has been given where the heater 104 is disposed inside the battery box 105, the heat control structure of the present disclosure can also be applied to the case where the heater 104 is not disposed.

Any embodiments of the above-described various embodiments can be combined as appropriate to achieve their respective effects.

### INDUSTRIAL APPLICABILITY

The present disclosure makes it possible to design and manufacture a power-saving satellite that minimizes heater operation in designing next-generation satellites that will carry out advanced and a wide variety of types of missions. Thus, it is expected to improve the design freedom of satellites, as well as greatly expand the range of use and the field of application of satellites, leading to commercial use.

### REFERENCE SIGNS LIST

101 battery
102 lead wire
103 buffer material
104 heater
105 battery box
106 interface between heater and battery box
107 interface between battery and battery box
108 heat insulator
109 heat insulator

1. A heat control structure comprising:
a heat insulator disposed between a housing for accommodating a heat control target mounted on a satellite and the heat control target, wherein
the heat insulator is disposed so as to be in contact with the housing and the heat control target,
the heat insulator contains at least silica aerogel, and
the heat insulator has a thermal resistance of 0.02 (m²·K)/W or more.

2. The heat control structure according to claim 1, wherein
the heat insulator has a first surface in contact with the heat control target and a second surface opposite the first surface in contact with the housing, and
the first surface has an area 1.2 times or more a contact area of the first surface in contact with the heat control target.

3. The heat control structure according to claim 1, wherein the heat insulator is silica aerogel.

4. The heat control structure according to claim 1, wherein the heat insulator includes silica aerogel and non-woven fibers.

5. The heat control structure according to claim 1, wherein the heat insulator includes silica aerogel, non-woven fibers, and a carbon material.

6. A satellite comprising the heat control target, the housing, and the heat control structure according to claim 1.

7. The satellite according to claim 6, comprising:
a battery,
a heater disposed around an exterior of the battery; and
a battery box that houses the battery and the heater, wherein
the battery and the heater are the heat control targets,
the battery box is the housing, and
the heat insulator is disposed between the battery and the housing and between the heater and the housing.
